(19) United States
(12) Patent Application Publication
(10) Pub. No.: US 2017/0192106 A1
(43) Pub. Date: Jul. 6, 2017

(54) CASCADED IONIZING RADIATION CONVERTER AND APPARATUS FOR DIAGNOSTIC IMAGING IN REAL TIME

(71) Applicant: WROCLAWSKIE CENTRUM BADAN EIT+ SP. Z O.O., Wroclaw (PL)

(72) Inventors: Adam JANUSZKO, Wroclaw (PL); Eugeniusz ZYCH, Wroclaw (PL)

(21) Appl. No.: 15/315,643

(22) PCT Filed: May 25, 2015
(86) PCT No.: PCT/PL2015/050018

§ 371 Date: Dec. 1, 2016

(30) Foreign Application Priority Data
Jun. 2, 2014 (PL) PL408391

(51) Int. Cl. G01T 1/20; G02F 1/137

(52) U.S. Cl. CPC G01T 1/2018; G02F 1/13731; G02F 2202/022

(57) ABSTRACT

The object of the present invention is an cascaded ionizing radiation converter, comprising the first conversion stage, transforming ionizing radiation into non-ionizing electromagnetic radiation, the second conversion stage transforming non-ionizing electromagnetic radiation into an electrical charge, and the third conversion stage transforming the generated electric charge into the change of potential controlling the liquid crystal cell, wherein the first conversion stage is a radioluminescent layer, preferably Lu₂O₃:Eu layer, the second conversion stage is a photoconductive material layer, preferably amorphous selenium or poly (3-hexyl-thiophene) layer, and the non-ionizing electromagnetic radiation emission spectrum of the first conversion stage corresponds with the non-ionizing electromagnetic radiation absorption spectrum of the second conversion stage; And an imaging diagnostic apparatus using cascaded ionizing radiation converter.

The present invention relates to a cascaded ionizing radiation converter for diagnostic imaging, usable in medical diagnostic devices and RTG scanners for air luggage inspection.

U.S. Pat. No. 4,368,386A discloses an image conversion device comprising a thick plate of photoconductive material being bismuth oxide, or a mixture of the latter with germanium or silicon oxide, characterized by high resistivity on lack of radiation and high photoconductivity. The said layer absorbs ionizing radiation, e.g. X-rays. The device further comprises a liquid crystal layer having nematic phase wherein the image is displayed, and power supply electrodes. Introduction of appropriate admixtures to the device allows for reading out information via white light since the absorption of this radiation is significantly reduced by the photoconductive material layer.

Scientific publication by P. Rieppo, B. Bahadur, J. Rowlands, titled “Amorphous selenium liquid crystal light valve for x-ray imaging,” Proc. SPIE 2432, Medical Imaging 1995: Physics of Medical Imaging, 228 (May 8, 1995), discloses equipment amplifying the x-ray image, comprising the layer absorbing Roentgen radiation, the image creation layer, and an amplifier stage. The device is based on a photoconductive x-ray detector creating the image. The said photoconductive detector comprises twisted nematic liquid crystal cells embedded in an amorphous selenium layer. Further on, the device comprises a polarizer which changes the intensity of the light transmitted by the whole structure. A CCD camera records the optical image and transmits it to the processor where it is subjected to digital processing and then displayed. The whole system, except for the image registering layer comprising liquid crystal cells with selenium layer, requires additionally a light source and a CCD camera to record. This fact determines the lack of compactness of the devices and increases both its production and operation costs.

U.S. Pat. No. 7,687,792, in turn, presents a digital system for X-ray diagnostic. The device is built of a photoconductive detector and an electro-optic modulator. The photoconductive detector layer absorbs x-rays that have passed through the examined object forming an exposure of the object stored in the electro-optic light modulator. In the embodiment of the patent referred to above, the photoconductive detector layer is amorphous selenium adjacent to the electro-optic modulator layer comprising liquid crystals. So created x-ray image is stable for a few minutes and can be digitized using a scanning system or a CCD camera. The said device records static images and does not allow for live preview. Furthermore, recording of the next image requires application of an erasing signal in the form of visible light of predefined range.

On the other hand, U.S. Pat. No. 5,847,499, presents a device generating x-ray images, comprising an x-ray radiation source, an x-ray detector consisting of a photoconductive layer of amorphous selenium of thickness from 50 to 500 pm, and an electro-optic modulator in the form of a liquid crystal cell. Furthermore, the device comprises a non-actinic (not exposing the photoconductive layer) light source in order to create optical representation of the exposed x-ray image, and an image converter receiving the image projected by means of non-actinic light, and a processor coupled with the imager in order to store and process the images. The said device comprises additional elements, like the second radiation source, the image converter or the processor, which makes it structurally complicated and therefore expensive in production and operation.

From U.S. Pat. No. 5,929,449, a thin-film, flat detection panel in the form of a pixelated matrix is known, serving as a real-time digital imager and dosimeter for diagnostic or x rays or gamma rays. It includes a plurality of photodiodes made of hydrogenated amorphous silicon placed upon a glass substrate. The key element of the said device is the layer converting x-ray or gamma rays into electric field, being a selenium layer of 300-500 μm thick. The electric field generated in the converting switches the TFT transistor of the corresponding pixel, thus creating a two-dimensional picture. The application of the selenium layer with the thickness of up to 0.5 mm poses a technological challenge and additionally reduces the transparency of the whole device, thus limiting the detection sensitivity. What's more, the process of depositing such a thick selenium layer can lead to formation of re-crystallites in the layer, which is a parasitic phenomenon due to the generation of dark current.

The technological problem faced by the present invention is to propose such a structure of the ionizing radiation converter and the x-ray imaging device that will use fewer components, will allow for real time imaging and readout with a naked eye, in transmission and reflection mode, will be transparent for visible light, will increase x-ray detection sensitivity, and limit the x-ray energy necessary for effective imaging, thus reducing the negative effects of this radiation upon the patient. Unexpectedly, the technical problems mentioned above have been solved by the present invention.

The first object of the present invention is an cascaded ionizing radiation converter, comprising the first conversion stage, transforming ionizing radiation into non-ionizing electromagnetic radiation, the second conversion stage transforming non-ionizing electromagnetic radiation into an electrical charge, and the third conversion stage transforming the generated electric charge into the change of potential controlling the liquid crystal cell, characterized in that the first conversion stage is a radioluminescent layer, preferably Lu₂O₃:Eu layer, the second conversion stage is a photoconductive material layer, preferably amorphous selenium or poly(3-hexylthiophene) layer, wherein the non-ionizing electromagnetic radiation emission spectrum of the first conversion stage is the same as the non-ionizing electromagnetic radiation absorption spectrum of the second conversion stage. Preferably, the non-ionizing electromagnetic radiation emission spectrum of the first conversion stage comprises visible radiation. Equally preferably, the radioluminescent layer thickness of the first conversion stage is within 100-200 μm. In another favorable embodiment of the present invention, the photoconductive material layer thickness is within 100-200 nm.

The second object of the present invention is an imaging diagnostic apparatus using ionizing radiation, having hybrid structure comprising the upper transparent layer made of a polymer, then the upper electrode layer, and, in sequence, the first conversion stage converting the ionizing radiation into non-ionizing electromagnetic radiation, the second conversion stage transforming non-ionizing electromagnetic radiation into an electrical charge, and the third conversion stage transforming the generated electric charge into the change of potential controlling the liquid crystal cell, then a polyimide layer, the lower electrode layer, and the lower transparent layer of polymer or glass, characterized in that the first conversion stage is a radioluminescent layer, preferably Lu₂O₃:Eu layer, the second conversion stage is a photoconductive material layer, preferably amorphous selenium or poly(3-hexylthiophene) layer, wherein the non-ionizing electromagnetic radiation emission spectrum of the first conversion stage is the same as the non-ionizing electromagnetic radiation absorption spectrum of the second conversion stage. Preferably, the non-ionizing electromagnetic radiation emission spectrum of the first conversion stage comprises visible radiation. Equally preferably, the radioluminescent layer thickness of the first conversion stage is within 100-200 μm. In another favorable embodiment of the present invention, the photoconductive material layer thickness is within 100-200 nm. In another preferable embodiment of the present invention, the upper electrode layer and the lower electrode layer are made of indium-tin oxide (ITO).

The cascaded ionizing radiation converter according to the present invention and the apparatus for imaging diagnostic using the cascaded ionizing radiation converter are characterized with simple structure limiting the number of components used, wherein the allow for real time imaging and results readout with a naked eye in transmission and reflection mode, they are transparent for visible light, and due to the application of direct conversion, the thickness of the first and the second conversion stage layers was reduced which positively influenced the ionizing radiation detection sensitivity and reduced the amount of ionizing radiation energy necessary for effective imaging, contributing to the limitation of the harmful effects of the said radiation upon the patient.

Exemplary embodiments of the invention have been presented in the drawings, wherein

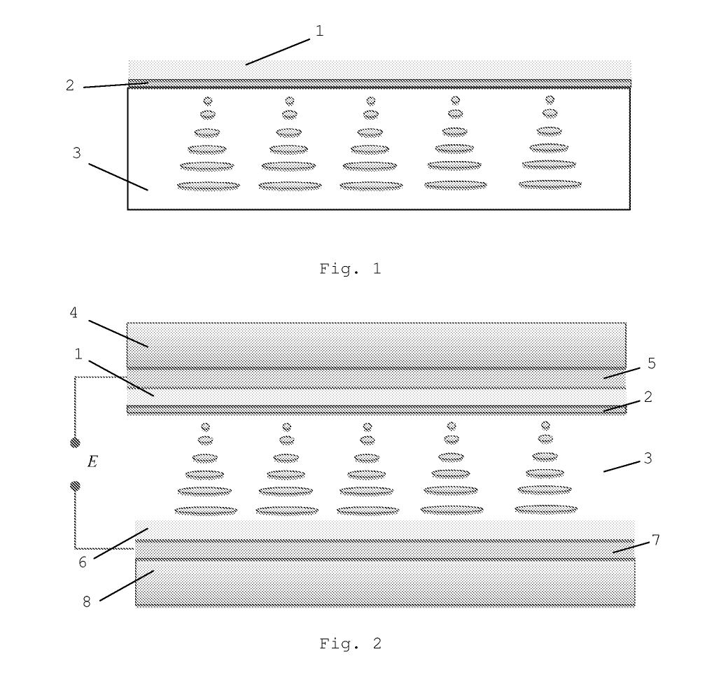

FIG. 1 is a schematic diagram of the cascaded ionizing radiation converter according to the present invention,

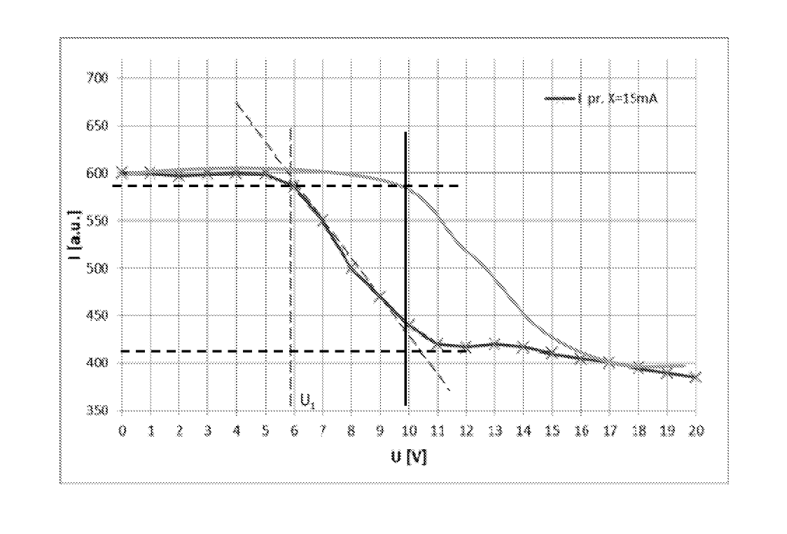

FIG. 2 is a schematic diagram of the imaging diagnostic apparatus according to the invention, while

FIG. 3 represents the chart illustrating of the intensity variation of the light transmitted by the ionizing radiation converter as the result of cascaded conversion.

### EXAMPLE 1

FIG. 1 shows the schematic representation of the cascaded ionizing radiation converter being the first embodiment of the present invention. The radiation cascaded converter consists of three conversion stages constituting separate layers in contact with each other. The first conversion stage 1 is used for converting the ionizing radiation into non-ionizing electromagnetic radiation. In the present embodiment, the first conversion stage 1 is a radioluminescent layer made of Lu₂O₃:Eu material 100 μm thick. The ionizing radiation in the form of x-rays with 5 keV to 350 keV energy is absorbed upon reaching the first conversion stage, and, as the result, non-ionizing electromagnetic radiation of 610 nm wavelength is generated. The electromagnetic radiation generated at the first conversion stage 1 is then cast upon the second conversion stage 2 that assumes the form of the photoconductive layer—amorphous selenium, 150 nm thick. The electromagnetic radiation from the first conversion stage 1 is absorbed by the amorphous selenium layer, which results in generation of electron-hole pairs influencing the change in electric field applied to the Converter. The electric field generated on the second conversion stage 2 is applied to the third conversion stage 3 that represents the screen of the cascaded ionizing radiation converter, assuming the form of liquid crystal cells of the twisted nematic (TN) type. Applying electric voltage to a liquid crystal cell results in twisting the crystals, which results in the liquid crystal cell transmission change from fully transparent to fully impermeable for electromagnetic radiation of the visible spectrum. Due to the implementation of multistage conversion, the cascaded ionizing radiation converter presented in the present embodiment of the invention is characterized with increased resolution as compared to the currently used solutions with a-Se layer only. Furthermore, using two thin layers on the first conversion stage 1 and on the second conversion stage 2 did not influence the reduction of transmittance of the whole system. Using only three layers, on the other hand, determines the necessity to use production technologies of lower requirements, thus reducing the production time and cost of such converter. Furthermore, the converter according to the present embodiment requires lower x-ray radiation energy for successful imaging. The above advantages are confirmed by research results presented in FIG. 3, where the chart illustrating the intensity variation of the light transmitted by the ionizing radiation converter as the result of cascaded conversion is presented. Three-stage conversion of ionizing radiation causes change of the threshold voltage from U1 to U2, which results in darkening the given liquid crystal cell due to liquid crystals twisting.

### EXAMPLE 2

FIG. 2 represents a schematic diagram of the imaging diagnostic apparatus using ionizing radiation, being the second embodiment of the present invention. The imaging diagnostic apparatus is of hybrid structure, i.e. asymmetric, and is characterized with layered structure. The first layer is the upper transparent layer 4 made of PVK (polyvinylcarbazole) polymer 100 μm thick. The polymer is transparent for x-rays. Under the upper transparent layer 4, is the upper electrode layer 5, made of indium-tin oxide (ITO) from 50 to 100 nm thick, which is commonly known in the art. Then there is a three-layer cascaded ionizing radiation converter, equivalent to the one presented in the first embodiment of the invention. The radiation cascaded converter consists of three conversion stages constituting separate layers in contact with each other. The first conversion stage 1 is used for converting the ionizing radiation into non-ionizing electromagnetic radiation. In the present embodiment, the first conversion stage 1 is a radioluminescent layer made of Lu₂O₃:Eu material 100 nm thick. The ionizing radiation in the form of x-rays projected onto the first conversion stage 1 is absorbed in the layer, and, as the result, non-ionizing electromagnetic radiation of 610 nm wavelength is generated. The electromagnetic radiation generated at the first conversion stage 1 is then cast upon the second conversion stage 2 which assumes the form of a photoconductive layer of poly(3-hexylthiophen) 200 nm thick. The electromagnetic radiation from the first conversion stage 1 is absorbed by the poly(3-hexylthiophen) layer, which results in generation of electron-hole pairs constituting the electric field. The next layer is the third conversion stage 3 that represents the screen of the cascaded ionizing radiation converter, assuming the form of liquid crystal cells of the twisted nematic (TN) type. Below, there is a polyimide layer 50-100 nm thick, whose task is to orient the output layer comprising liquid crystal cells. The next layer is the lower electrode layer also made of indium-tin oxide (ITO) from 50 to 100 nm thick. The last layer is the lower transparent layer made of glass, being the mechanical protection. So created hetero-structure is duplicated and manufactured in the form of a two-dimensional matrix, which allows for x-ray imaging of objects. The electron-hole pairs generated on the second conversion stage 2 are separated in the result of application of fixed voltage between the upper electrode layer 5 and the lower electrode layer 7, which causes control voltage increase. As the result, the liquid crystals on the third conversion stage 3 are twisted and the single cell goes dark. The embodiments of the imaging diagnostic apparatus presented in this example are characterized with simple structure and uncomplicated manufacturing process. The application of a polymer and ITO based electrodes enabled, apart from the possibility to control the liquid crystal cell orientation, minimization of ionizing radiation absorption on these layers. The thickness of the first conversion stage 1 and the second conversion stage 2 layers influence the increase of the diagnostic apparatus sensitivity. Furthermore, the apparatus according to the present embodiment requires lower x-ray radiation energy for successful imaging.

1. The cascaded ionizing radiation converter, comprising the first conversion stage (1) transforming ionizing radiation into non-ionizing electromagnetic radiation, the second conversion stage (2) transforming non-ionizing electromagnetic radiation into an electrical charge, and the third conversion stage (3) transforming the generated electric charge into the change of potential controlling the liquid crystal cell, characterized in that the first conversion stage (1) is a radioluminescent layer, preferably Lu₂O₃:Eu layer, the second conversion stage (2) is a photoconductive material layer, preferably amorphous selenium or poly (3-hexylthiophene) layer, wherein the non-ionizing electromagnetic radiation emission spectrum of the first conversion stage (1) corresponds with the non-ionizing electromagnetic radiation absorption spectrum of the second conversion stage (2).

2. Cascaded ionizing radiation converter of claim 1, characterized in that the non-ionizing electromagnetic radiation emission spectrum of the first conversion stage (1) comprises visible radiation.

3. Cascaded ionizing radiation converter of claim 1, characterized in that the radioluminescent layer thickness of the first conversion stage (1) is within 100-200 μm.

4. Cascaded ionizing radiation converter of claim 1, characterized in that the thickness of the photoconductive material layer of the second stage (2) is within 100-200 nm range.

5. An imaging diagnostic apparatus using ionizing radiation, having hybrid structure comprising the upper transparent layer (4) made of a polymer, then the upper electrode layer (5), and, in sequence, the first conversion stage (1) converting the ionizing radiation into non-ionizing electromagnetic radiation, the second conversion stage (2) transforming nonionizing electromagnetic radiation into an electrical charge, and the third conversion stage (3) transforming the generated electric charge into the change of potential controlling the liquid crystal cell, then a polyimide layer (6), the lower electrode layer (7), and the lower transparent layer (8) made of a polymer or of glass, characterized in that the first conversion stage (1) is a radioluminescent layer, preferably Lu₂O₃:Eu layer, the second conversion stage (2) is a photoconductive material layer, preferably amorphous selenium or poly (3-hexylthiophene) layer, wherein the non-ionizing electromagnetic radiation emission spectrum of the first conversion stage (1) corresponds with the non-ionizing electromagnetic radiation absorption spectrum of the second conversion stage (2).

6. Imaging diagnostic apparatus of claim 5, characterized in that the non-ionizing electromagnetic radiation emission spectrum of the first conversion stage (1) comprises visible radiation.

7. Imaging diagnostic apparatus of claim 5, characterized in that the radioluminescent layer thickness of the first conversion stage (1) is within 100-200 μm.

8. Imaging diagnostic apparatus of claim 5, characterized in that the thickness of the photoconductive material layer of the second conversion stage (2) is within 100-200 nm range.

9. Imaging diagnostic apparatus of claim 5, characterized in that the upper electrode layer (5) and the lower electrode layer (7) are made of indium-tin oxide (ITO).
